(19) United States
(12) Patent Application Publication
(10) Pub. No.: US 2005/0045011 A1
(43) Pub. Date: Mar. 3, 2005

(54) Food slicer with a rotary knob

(75) Inventors: Peter Kovacic, Gomilsko (SI); Aleksander Sedovsek, Mozirje (SI); Uros Semeja, Smartno ob Paki (SI); Jozef Skoncnik, Recica (SI)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/928,303

(22) Filed: Aug. 27, 2004

Related U.S. Application Data
(63) Continuation of application No. PCT/EP03/01757, filed on Feb. 20, 2003.

(30) Foreign Application Priority Data
Feb. 27, 2002 (DE) 102 08 476.9

(51) Int. Cl. B26D 1/14; B23D 19/00

(52) U.S. Cl. 83/478; 83/717

(57) ABSTRACT

A food slicer has a housing with a front wall that serves as a positioning plate and a back wall formed with an opening in which a rotary knob is mounted for adjusting the positioning plate. The rotary knob has a threaded section, a handle section, and a catch device. The rotary knob, which adjusts the cutting width upon rotation, becomes dirty only slightly during use and it is easy to clean. The catch device is configured such that, when the knob is mounted in the housing, it is covered and cannot be seen from the outside. The advantage thereof is that dirt is prevented from being deposited on protruding catching hooks or on sections of the housing or on the rotational handle.

### CROSS-REFERENCE TO RELATED APPLICATION

This is a continuing application, under 35 U.S.C. § 120, of copending international application No. PCT/EP03/01757, filed Feb. 20, 2003, which designated the United States; this application also claims the priority, under 35 U.S.C. § 119, of German patent application No. 102 08 476.9, filed Feb. 27, 2002; the prior applications are herewith incorporated by reference in their entirety.

### BACKGROUND OF THE INVENTION

1. Field of the Invention

The invention relates to a food slicer having a housing with a front wall serving as a positioning plate. A rear wall is formed with an opening wherein a rotary knob for adjusting the positioning plate is located. The rotary knob is provided with a threaded portion, a grip portion, and a catch device.

Food slicers or food slicers with a positioning plate that can be adjusted by way of a rotary knob are well known in the art. By rotating the rotary knob, the positioning plate is displaced in its position in relation to a circular blade of the food slicer. The relative displacement of the positioning plate and the round blade, which is a parallel displacement, defines the slicing thickness for the portions of the product for slicing.

In the prior art food slicer, the rotary knob is formed by a pot-shaped grip portion which is connected to a disk-shaped portion of considerably greater diameter. Catch hooks are formed on the rotary knob between the disk-shaped portion and the pot-shaped grip portion. Such a rotary knob can be rotatably mounted in a circular opening in a housing wall. In order to mount such a rotary knob rotatably in the housing, the prior art rotary knob is guided through the circular opening from the rear side of the housing wall with the pot-shaped grip portion first. The pot-shaped grip portion is introduced into the circular opening until the disk-shaped portion of the rotary knob bears against the rear side of the housing wall. In this position, the catch hooks arranged over the periphery of the pot-shaped grip portion can spread on the front side of the housing wall, and the rotary knob is engaged rotatably in the circular opening of the housing wall.

It is a disadvantage of the known mounting of the rotary knob in a housing of the food slicer that the catch noses are visible from the outside. In most cases, the catch noses of the rotary knob are formed directly on the grip portion, and, to obtain the elasticity of the formed-on catch hooks, it is necessary for wall cutouts to be provided on the pot-shaped grip portion, by means of which a certain elasticity of the catch hooks is achieved. The consequence of this is that the rotary knob has cutouts on its grip portions. These cutouts are located on the very surface by which the user acts on the rotary knob. Both the outwardly projecting catch hooks and the cutouts located on the grip portion render cleaning of the food slicer more difficult. For easy cleaning of the food slicer, it would be desirable for the visible surfaces of the food slicer to be of as smooth-walled a design as possible, in order that only little dirt can collect and dirt can be removed easily.

### SUMMARY OF THE INVENTION

It is accordingly an object of the invention to provide a rotary knob assembly for setting the slicing width of a food slicer which overcomes the above-mentioned disadvantages of the heretofore-known devices and methods of this general type and which provides a food slicer that becomes only slightly dirty in use and which is easy to clean. A further object of the invention is for it still to be possible, in spite of improved cleanability of the food slicer, to manufacture it conveniently and assemble it simply.

With the foregoing and other objects in view there is provided, in accordance with the invention, a slicer, comprising:
a housing having a front wall serving as a positioning plate and a rear wall having an opening formed therein;
a rotary knob assembly for adjusting the positioning plate mounted in the opening in the rear wall;
the rotary knob assembly having a threaded portion, a grip portion, and catch means configured and disposed to be concealed from view from an outside when the rotary knob assembly is mounted in the opening in the housing.

In other words, the objects of the invention are achieved with these features. Due to the fact that the catch means that mounts the rotary knob rotatably in the housing is designed in such a way that it is concealed invisibly from the outside when in an inserted position in the housing, dirt is prevented from collecting on projecting catch hooks or on cutouts which are present.

In accordance with a preferred embodiment of the food slicer according to the invention, the catch means is arranged on a first cylindrical surface portion of the rotary knob between the threaded portion and the grip portion and the catch means is, in the inserted position, concealed by a second cylindrical surface portion of the housing. By virtue of this construction, a very small annular gap is brought about between the rotatably mounted rotary knob and the associated housing wall. Both the catch means and any necessary cutouts are then located in the interior of the housing. A very small annular gap, into which only little dirt can penetrate, is formed between the first cylindrical surface portion of the rotary knob and the second cylindrical surface portion of the housing. In a preferred embodiment, the second cylindrical surface portion is set back inwardly from the rear wall of the housing. In this construction, the grip portion of the rotary knob does not project or projects only to a small extent from the surface of the housing. Predominantly smooth surface transitions are brought about, which render cleaning of the food slicer easier.

In accordance with an additional feature of the invention, the catch means are formed by a number of catch hooks which are distributed over a periphery of the rotary knob and engage in a cylindrical wall portion at the opening of the housing. By designing a cylindrical wall portion at the opening of the housing, the catch hooks of the rotary knob can engage in a groove in the cylindrical wall portion. Both the catch hooks and the groove are covered by the cylindrical wall portion and are not visible from the outside in the mounted state.

Instead of providing the catch hooks on the rotary knob and the annular groove on the housing, the annular groove, wherein associated catch hooks designed on the rear wall of the housing at least in proximity to the opening engage, can be designed on the rotary knob. This has the advantage that the rotary knob has no elastic elements, i.e. catch hooks, and the rotary knob can be produced in a simple and cost-effective way. The elastic catch hooks can be formed additionally on the generally considerably complicatedly designed housing without this having a disadvantageous effect on the production of the housing. If the catch hooks are provided on the housing, any necessary cutouts, which ensure the elasticity of the catch hooks, are located on the housing as well. In contrast to the housing, the rotary knob then has no cutouts. This has the advantage that precisely the rotary knob, which is exposed to dirt to a greater extent by use, has no cutouts wherein dirt could collect.

The catch hooks are preferably formed on the inner side of the rear wall of the housing. The catch hooks can therefore be manufactured cost-effectively together with the housing as an injection-molded plastic part.

Preferably, at least three catch hooks are provided, which are distributed uniformly over the peripheral edge of the opening in the housing. As at least three catch hooks are provided, a stable rotatable mounting of the rotary knob in the housing is brought about.

In an advantageous variant, a disk-shaped surface portion, on the rear side of which a threaded portion is formed and on the front side of which a first cylindrical surface portion which comprises an annular groove is formed, is provided on the rotary knob. The disk-shaped surface portion forms a bearing surface at the rear side of the housing. An associated threaded portion of the positioning plate engages in the threaded portion of the rotary knob. By rotating the rotary knob, the positioning plate can be moved in the axial direction in relation to the round blade by means of the mutually engaging threaded portions.

It is especially advantageous if the first cylindrical surface portion extends as far as the outer edge of the opening. The circular outer edge of the rotary knob then ends at the circular inner edge of the opening in the housing. This makes possible a stepless transition between the grip portion of the rotary knob and the adjacent wall portion of the housing. This improves the cleanability of the food slicer.

The first cylindrical surface portion of the rotary knob can have an outer lateral surface which bears against an inner lateral surface of the second cylindrical surface portion at the housing opening. This results in additional stabilization of the rotatable mounting of the rotary knob in the housing. The outer lateral surface of the first cylindrical surface portion then forms together with the inner lateral surface of the second cylindrical surface portion a guide like a sliding bearing. Owing to the relatively wide design of the outer and inner lateral surfaces, an annular gap with a very great sealing effect is brought about.

Other features which are considered as characteristic for the invention are set forth in the appended claims.

Although the invention is illustrated and described herein as embodied in a food slicer with a rotary knob, it is nevertheless not intended to be limited to the details shown, since various modifications and structural changes may be made therein without departing from the spirit of the invention and within the scope and range of equivalents of the claims. Particularly the term food slicer should be understood as a generic term and the use of the slicer according to the invention is not limited to these applications.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a partial perspective view of a food slicer according to the invention;

FIG. 2 is a perspective view of a rotary knob according to the invention;

FIG. 3 is a rear perspective view of a part of the housing with an opening for the rotary knob;

FIG. 4 is a rear perspective view showing the rotary knob according to FIG. 2 in the mounted position on the housing according to FIG. 3;

FIG. 5 is a cross section taken through a part of the food slicer according to the invention; and

FIG. 6 is a similar view illustrating an alternative embodiment of the invention.

### DESCRIPTION OF THE PREFERRED EMBODIMENTS

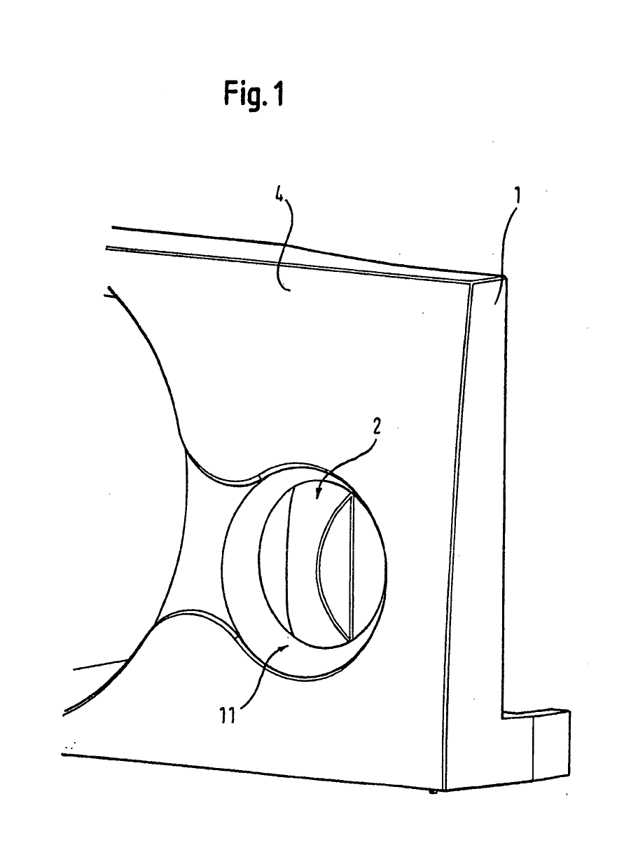

Referring now to the figures of the drawing in detail and first, particularly, to FIG. 1 thereof, there is shown a portion of a food slicer according to the invention which has a housing 1. The housing 1 comprises a rear wall 4 that is formed with an opening 11 for a rotary knob 2. The rotary knob 2 is set back, or sunk, in relation to the surface of the rear wall 4. The edge of the rotary knob 2 adjoins the edge of the opening 11 in the rear wall 4 of the housing 1 directly. Owing to the mounting according to the invention of the rotary knob 2 in the opening 11 of the housing 1, the required catch assembly is concealed towards the outside. On the one hand, this results in an attractive exterior, and, on the other hand, there are no catch means projecting over the outer surface and no exposed cutouts, on which dirt can accumulate.

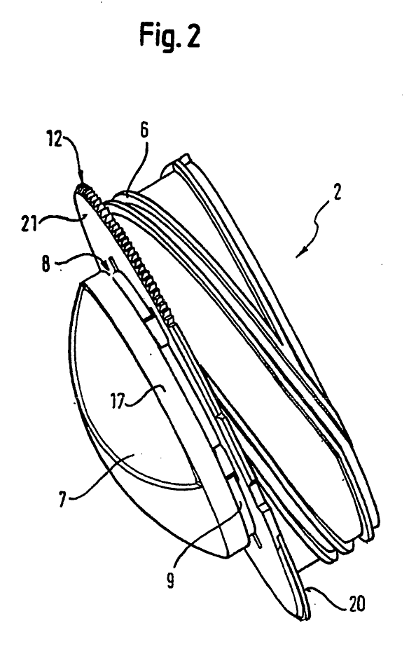

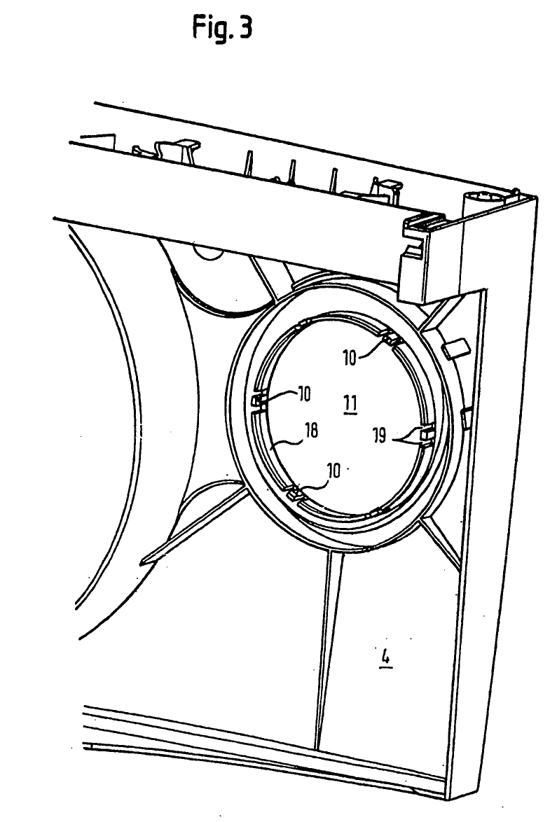

FIG. 2 shows the rotary knob assembly 2 or, for short, the rotary knob 2, in detail. The rotary knob 2 has a disk-shaped surface portion 12 which has a rear side 20 and a front side 21. A threaded portion 6 with a race adjoins the rear side 20. A grip portion 7 adjoins the front side 21. A cylindrical surface portion 17 is disposed between the grip portion 7 and the front side 21. In the fitted position, the cylindrical surface portion 17 comes to lie on an associated cylindrical surface portion 18 (FIG. 3) of the housing 1. An annular groove 9, which forms the catch means 8 on the rotary knob 2, is formed between the cylindrical surface portion 17 and the front side 21, or in other words, in the cylindrical surface portion 17 and adjoining the front side 12 of the disk-shaped surface portion 12.

FIG. 3 illustrates the cylindrical surface portion 18 of the housing 1. In the fitted position, the cylindrical surface portion 18 of the housing 1 bears the rotary knob 2 at its cylindrical surface portion 17 (FIG. 2). Catch hooks 10 are formed by pairs of cutouts 19 on the cylindrical surface portion 18. The catch hooks 10 engage in the annular groove 9 on the rotary knob 2 (FIG. 2). The catch hooks 10 are set back in relation to the outer surface of the rear wall 4.

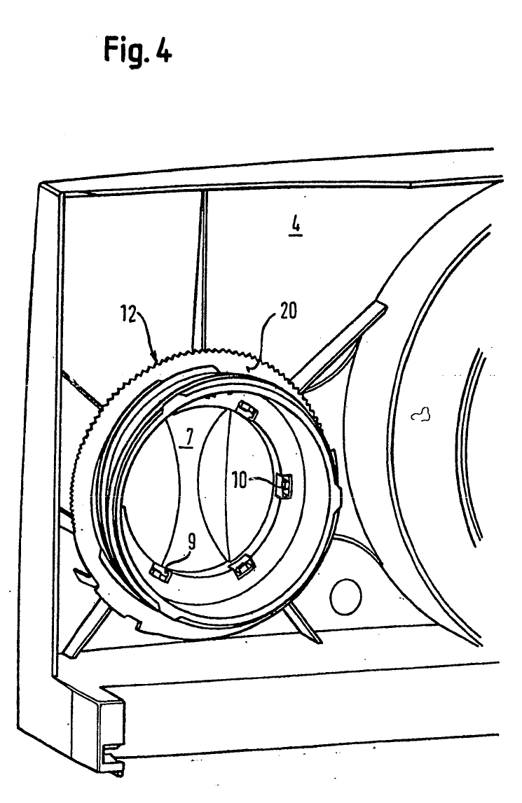

FIG. 4 shows the rotary knob 2 from FIG. 2 in the fitted state in the rear wall 4 of the housing 1 from FIG. 3.

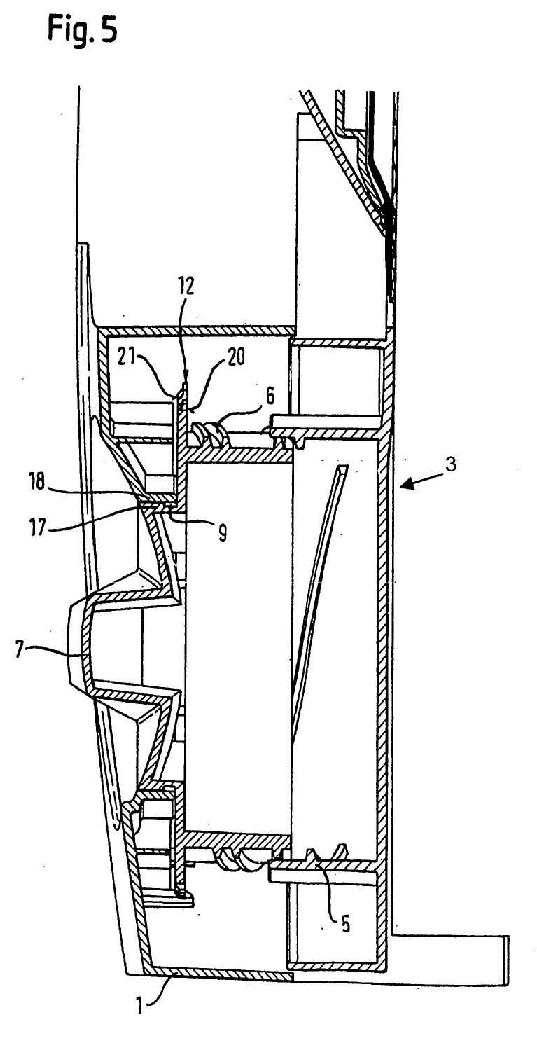

In FIG. 5, the rotary knob 2 is illustrated in section in the fitted position in the housing 1. The rotary knob 2 has the disk-shaped surface portion 12. The threaded portion 6 is formed in one piece on the rear side 20 of the disk-shaped surface portion 12. The cylindrical surface portion 17 is formed in one piece on the front side 21 of the disk-shaped surface portion 12. The cylindrical surface portion 17 has the annular groove 9 on its outer periphery. The grip portion 7 is formed on an end of the cylindrical surface portion 17 lying opposite the edge of the annular groove. The rotary knob 2 designed in one piece is rotatably mounted in the housing 1.

The guiding bearing takes place by means of the cylindrical surface portion 17 of the rotary knob 2, which bears against the housing 2 in the cylindrical surface portion 18.

The functionality of the rotary knob assembly 2 is also indicated in FIG. 5. The portion of the housing 1 having the front wall 3 with the positioning plate is movably disposed relative to the rear wall 4. The thread 6 meshes with a corresponding thread 5 in the front wall portion of the housing. By rotating the rotary knob 2 at the grip portion 7, the meshing threads 5 and 6 cause the front wall 3 to translate relative to the rear wall 4. That is, the rotation either pulls the front and rear walls closer together or pushes them farther apart. As a result, the rotation of the rotary knob 2 translates the positioning plate of the slicer relative to the slicer blade and thus sets the slicing thickness of the slicer.

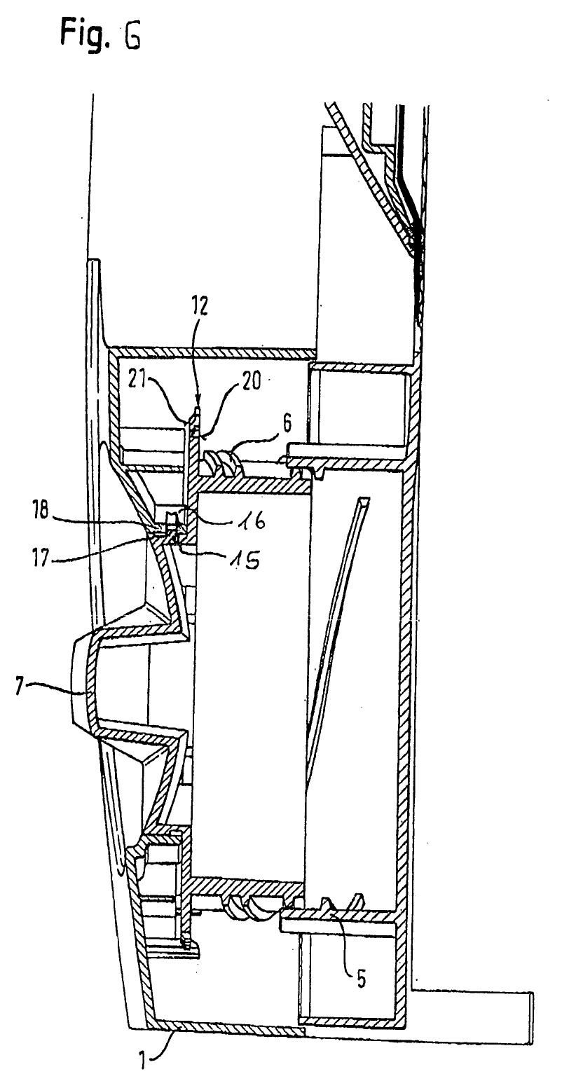

FIG. 6 illustrates an embodiment that is slightly different from the embodiment of FIG. 5. Here, the catch means are formed by a number of catch hooks 15 which are distributed over a periphery of the rotary knob and engage in a cylindrical wall portion 16 at the opening of the housing. By designing a cylindrical wall portion at the opening of the housing, the catch hooks 15 of the rotary knob can engage in the groove 16 in the cylindrical wall portion. Both the catch hooks and the groove are covered by the cylindrical wall portion and are not visible from the outside in the mounted state.

1. A slicer, comprising:
a housing having a front wall serving as a positioning plate and a rear wall having an opening formed therein;
a rotary knob assembly for adjusting the positioning plate mounted in said opening in said rear wall;
said rotary knob assembly having a threaded portion, a grip portion, and catch means configured and disposed to be concealed from view from an outside when said rotary knob assembly is mounted in said opening in said housing.

2. The slicer according to claim 1, wherein said rotary knob assembly is formed with a first cylindrical surface portion between said threaded portion and said grip portion, said housing is formed with a second cylindrical portion at said opening, said catch means is disposed on said first cylindrical surface portion, and said catch means, in the mounted position of said rotary knob assembly, is concealed by said second cylindrical surface portion of said housing.

3. The slicer according to claim 2, wherein said second cylindrical surface portion is set back inwardly from said rear wall of said housing.

4. The slicer according to claim 1, wherein said catch means is formed with a plurality of catch hooks which are distributed over a periphery of said rotary knob assembly and engage in a cylindrical wall portion formed at said opening in said housing.

5. The slicer according to claim 1, wherein the catch means is formed with an annular groove on said rotary knob assembly configured to receive and engage associated catch hooks formed on said rear wall at said opening.

6. The slicer according to claim 5, wherein said catch hooks are disposed on an inner side of said rear wall.

7. The slicer according to claim 6, wherein said catch hooks are formed on said rear wall.

8. The slicer according to claim 7, wherein said catch hooks number at least three, and said catch hooks are uniformly distributed over a peripheral edge of said opening.

9. The slicer according to claim 5, wherein said rotary knob assembly further comprises a disk-shaped surface portion, having a rear side formed with said threaded portion and a front side formed with a first cylindrical surface portion having said annular groove formed therein.

10. The slicer according to claim 9, wherein said first cylindrical surface portion extends to an outer edge of said opening.

11. The slicer according to claim 6, wherein said first cylindrical surface portion has an outer lateral surface bearing against an inner lateral surface of said second cylindrical surface portion.
